(19) United States
(12) Patent Application Publication
(10) Pub. No.: US 2011/0204077 A1
(43) Pub. Date: Aug. 25, 2011

(54) PAPER CUTTING CONTROL DEVICE FOR TICKET PAPER AND TICKET DISPENSING MACHINE COMPRISING THE SAME

(76) Inventors: Changgang Gu, Weihai (CN); Zhigang Xu, Weihai (CN); Lei Che, Weihai (CN); Weiwei Xu, Weihai (CN); Xiaoyan Gao, Weihai (CN)

(21) Appl. No.: 13/126,462

(22) PCT Filed: Oct. 28, 2009
(86) PCT No.: PCT/CN09/74644

§ 371 Date: Apr. 28, 2011

(30) Foreign Application Priority Data
Oct. 30, 2008 (CN) 200810173602.1

(51) Int. Cl. G07B 5/02; B65D 83/12; B65H 35/06; B65H 43/08

(52) U.S. Cl. 221/30; 83/396; 83/365; 83/62

(57) ABSTRACT

A paper cutting control device for ticket paper and ticket dispensing machine comprising the same, wherein the paper cutting control device for ticket paper comprises a driving motor (M), a first sensor (2), a cutter (3), a controller and a second sensor (4). The first sensor is located on an upstream of the cutter and used for detecting a spacing mark (B) between adjacent tickets of the ticket paper and sending a spacing mark arrival signal when the spacing mark is detected. The second sensor is located on a downstream of the cutter and used for detecting a front end of the ticket paper and sending a ticket arrival signal when the front end of the ticket paper is detected. A ticket dispensing machine has the paper cutting control device for ticket paper.

The present application claims priority of Chinese Patent Application No. 200810173602.1 submitted to the Chinese Patent Bureau on Oct. 30, 2008, entitled “Paper Cutting Control Device for Ticket Paper and Ticket Dispensing Machine comprising the same”, the disclosure of which is incorporated in the present application by reference herein in its entirety.

### FIELD OF THE INVENTION

The present invention relates to ticket processing technology, and in particular, to a paper cutting control device for ticket paper. Moreover, the present invention relates to a ticket dispensing machine using the above mentioned paper cutting control device for ticket paper.

### BACKGROUND OF THE INVENTION

Tickets are widely used in various fields and are characterized by large quantity and unified format in use.

At present, the ticket dispensing gets more normalized as most of the various valuable tickets have been dispensed by being printed by a ticket dispensing machine. According to the above utilization characteristics of the tickets, the blank ticket papers printed in advance are used as papers fed to the ticket dispensing machine when the ticket is to be dispensed by being printed by the machine; most of the blank ticket papers are tubular-shaped or folded continuous papers with each ticket occupying a fixed length and adjacent tickets being separated by a special cutting line. In operation, the ticket paper is driven by a driving motor to run along its conveying track, the ticket dispensing machine prints on the current ticket at the front end of the ticket paper according to the input contents to be printed, and automatically carries out the paper cutting action after the printing is completed to separate the current ticket from the ticket paper. The ticket paper including a number of blank tickets becomes a valid ticket with objective contents after going through the above processes. All of the train tickets, bus tickets, lottery tickets, boarding checks, etc. commonly used in life are dispensed in the above manner.

During the dispensing process, it is quite important to precisely cut the tickets of printed continuous paper, because the printed contents and the formality contents on the blank ticket will be mixed up if the cutting is inappropriate; in addition, in the process of successive dispensing, normal successive dispensing will also fail if an error occurs during paper feeding.

A spacing mark B is provided between adjacent tickets of the ticket paper to make the ticket have a fixed length in order to precisely cut the ticket paper. The spacing mark B is usually in the form of a black mark or a blank interval. A black spacing mark B1 is printed between the adjacent tickets A1 and A2 as shown in FIG. 1A, and the adjacent tickets A1 and A2 are bridged as shown in FIG. 1B, and a blank interval B2 therebetween acts as spacing mark separating the adjacent tickets.

FIG. 2 shows a paper cutting control device for ticket paper of a traditional ticket dispensing machine. The conveying track of the ticket paper of the device shown in the figure is a straight line, while the conveying track of the ticket paper also may be a circular track in practice. As shown in the figure, along the ticket paper conveying direction, a paper inlet 100, a paper delivering roller 1 driven by a motor M to move, a first sensor 2 and a cutter 3 are provided in turn on the paper conveying path. The distance from the detection position of the first sensor 2 on the ticket paper to the cutting position of the cutter 3 is d1 on the conveying track of the ticket paper. A controller (not shown in the figure) controls the driving motor M to continue to run for a first predetermined time T1 when the first sensor 2 detects a spacing mark B. The driving motor M stops running when the first predetermined time T1 is reached. At this moment, the ticket paper just has continued to move the line distance d1 along its conveying track, and the spacing mark B thereof is just located at the cutting position of the cutter 3, the controller controls the cutter 3 to perform the paper cutting action, and thus, the current ticket will be separated from the ticket paper.

The ticket dispensing can be effectively implemented in most cases in the prior art above, but there are still many problems. First, as the paper cutting position is judged merely depending on the spacing mark B, the correct paper cutting position possibly cannot be arrived at when running a preset first time T1 after the spacing mark B is detected, when an abnormality such as paper slipping or path blocking occurs to the ticket paper conveying path, at that time, the controller still controls the cutter to perform the paper cutting operation as it does not know the abnormality, finally causing the paper to be cut at an incorrect position and the dispensed tickets to be nonstandard, even abandoned. In the case where successive ticket dispensing is required, it may cause the situation that the abnormality is not observed for a long time, resulting in time waste and a plurality of ticket dispensing errors. Another problem is that the spacing mark B is quite easy to be missed during the process of fabricating the ticket paper, and if the spacing mark is missed during printing or the bridging interval is blocked, the first sensor 2 cannot determine whether the ticket has moved to the paper cutting position since it cannot detect the spacing mark B, then, the paper cutting opportunity is missed and the ticket dispensing efficiency is reduced.

Strict demands are usually put to the ticket printing, for example, each invoice should be provided with a serial number in invoice printing, and complex subsequent processing is required once an error occurs, therefore, it is still troublesome even if a failure occasionally takes place.

Regarding the above problems, some solutions have been provided in the prior art. For example, the running time of the driving motor is set in advance, and in the case that the spacing mark B is not detected, if the running time of the driving motor starting from the last paper cutting position goes beyond the running time set in advance, the spacing mark B is judged to be missed, the driving motor is stopped directly, and the paper cutting operation is performed. However, in the situation that the paper slips or the passage is blocked, the ticket paper cannot be enabled to arrive at the correct paper cutting position when the driving motor runs for a fixed time. Therefore, this technical solution always cannot solve the problems.

### SUMMARY OF THE INVENTION

In view of the above defects, the technical problem to be solved by the present invention lies in providing a paper cutting control device for ticket paper capable of implementing correct paper cutting control in the situation that the spacing mark is missed. A further preferable solution of the control device can also give an alarm to draw attention of the operator in time in the case where the ticket paper conveying path is abnormal.

Moreover, the present invention provides a ticket dispensing machine using the above mentioned paper cutting control device for ticket paper.

The paper cutting control device for ticket paper provided in the present invention comprises a driving motor, a first sensor, a cutter and a controller; wherein the driving motor supplies power to paper discharging movement to make the ticket paper move on a conveying track thereof; the first sensor is used for detecting a spacing mark between adjacent tickets of the ticket paper and sending a spacing mark arrival signal when the spacing mark is detected; the cutter is used for cutting the ticket paper, and a cutting position thereof is located on a downstream of a detection position of the first sensor on the conveying track of the ticket paper; the controller is used for receiving a detection result of each sensor and controlling actions of the driving motor and the cutter accordingly; and the paper cutting control device for ticket paper further comprises a second sensor on the conveying track of the ticket, which is used for detecting a front end of the ticket paper and sending a ticket arrival signal when the front end of the ticket paper is detected, and, a detection position of the second sensor is located on a downstream of the cutter.

Preferably, the second sensor has already detected or just detects that the front end of the ticket paper arrives at the detection position thereof when the ticket paper arrives at the correct cutting position.

Preferably, the spacing mark between adjacent ticket papers is a black mark or a blank interval.

Preferably, the first sensor and second sensor are photoelectric sensors.

Preferably, the controller controls in following way:

the controller starts timing if receiving a spacing mark arrival signal sent by the first sensor; and
if a signal of the front end of the ticket arrival sent by the second sensor has been received or is just received when the controller timing reaches the first predetermined time T1, the controller controls the driving motor to stop running at this moment and controls the cutter to cut the paper.

Preferably, the first predetermined time allows an error range to be set.

Preferably, an abnormality alarm indication is given if the signal of the front end of the ticket arrival sent by the second sensor has not yet been received when the controller timing reaches the first predetermined time T1.

Preferably, the controller starts timing when receiving the signal of the front end of the ticket arrival sent by the second sensor if the controller does not receive the spacing mark arrival signal sent by the first sensor but receives the signal of the front end of the ticket arrival sent by the second sensor, and the controller controls the driving motor to stop running and controls the cutter to cut the paper when the timing reaches a second predetermined time T2.

Preferably, a time limit which is timed from starting delivering the paper is preset in the controller; and an abnormality alarm indication is given if the controller neither receives the spacing mark arrival signal sent by the first sensor nor receives the signal of the front end of the ticket arrival sent by the second sensor after the time limit is reached.

Moreover, the present invention provides a ticket dispensing machine having the paper cutting control device for ticket paper in any one of the solutions above.

Compared with the prior art, the paper cutting control device for ticket paper provided in the present invention is provided with a new second sensor. Detecting the status of the front end of the current ticket with the second sensor can judge whether the paper feeding is normal, which can be taken as the basis of cutting paper. With this technical solution, the abnormalities such as ticket paper slipping or path blocking could be discovered in time so as not to cause paper cutting error that leads to mistakes in ticket dispensing.

Based on the basic technical solution above, a preferable solution of the present invention further takes the mode of detecting the status of the front end of the current ticket with the second sensor as standby mode of judging the paper cutting position. Once an abnormality occurs to the mode depending upon the spacing mark, the paper cutting position still can be quite precisely determined using the standby mode. Such mode, compared with the prior art, is less affected by the passage failure and usually no remarkable error will occur to the paper cutting position.

In a further preferable solution of the present invention, it is judged whether an abnormality occurs based on the detection situations by the first and second sensors and the time limit set for the driving motor, and an alarm is given when the abnormality occurs, thereby avoiding the case where the occurrence of passage failure cannot be discovered for a long time in the prior art and facilitating to deal with the failure in time.

### BRIEF DESCRIPTION OF THE DRAWINGS

FIG. 1A is a schematic view that adjacent tickets of the ticket paper take a black mark as spacing mode;

FIG. 1B is a schematic view that adjacent tickets of the ticket paper take a blank interval as spacing mode;

FIG. 2 is a schematic view of the principle of the paper cutting control device for ticket paper in the traditional ticket dispensing machine;

FIG. 3 is a schematic view of the principle of the paper cutting control device for ticket paper provided in the embodiment of the present invention; and

FIG. 4 is a flow chart of controlling of the paper cutting control device for ticket paper provided in the embodiment of the present invention.

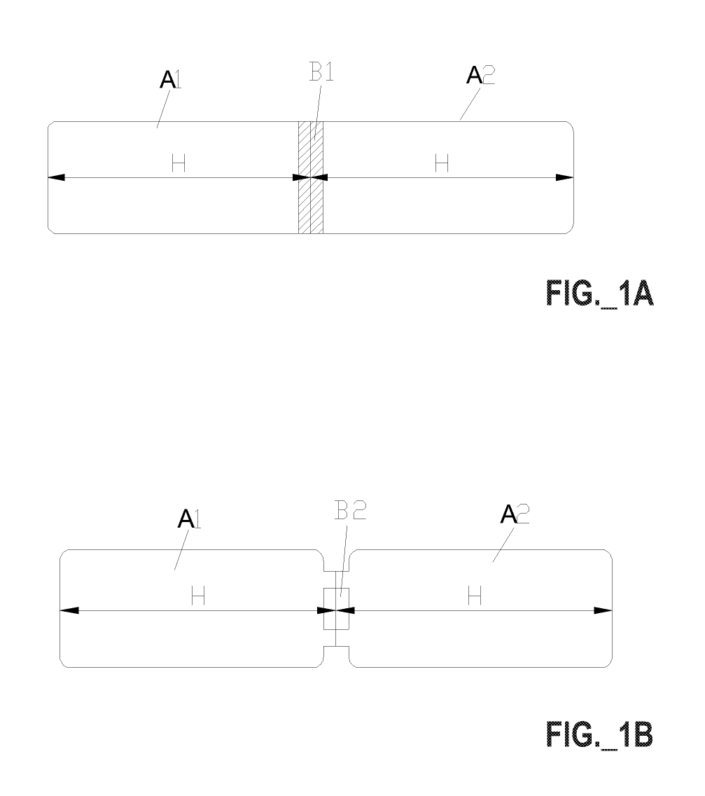

### DETAILED DESCRIPTION OF EMBODIMENTS

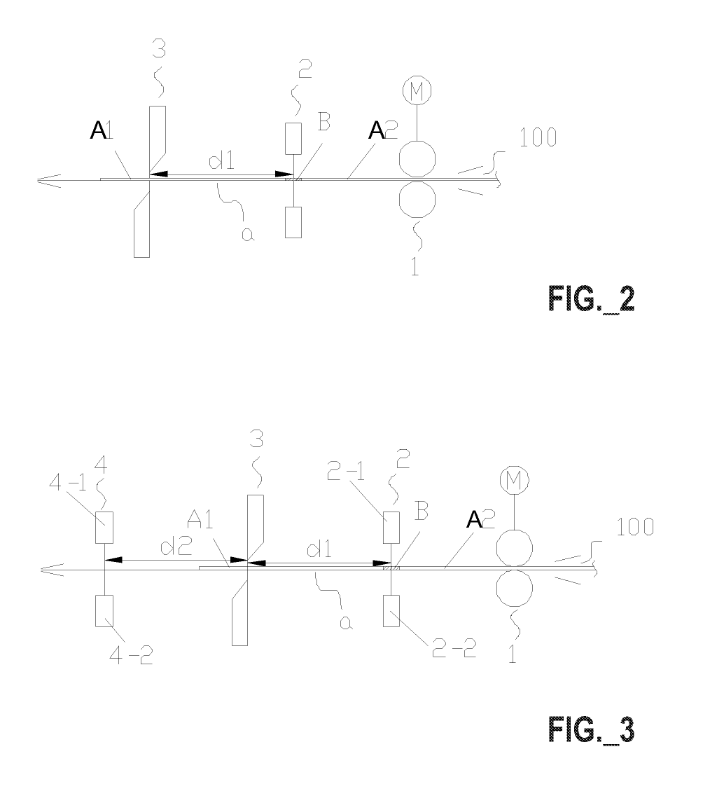

FIG. 3 is a schematic view of the principle of the paper cutting control device for ticket paper provided in the embodiments of the present invention. For the sake of easy explanation, suppose that the conveying track provided by the ticket dispensing machine to the ticket paper is a straight-line track in this embodiment, but in practice, the conveying track provided by the ticket dispensing machine to the ticket paper also can be a circular track. Regardless of the type of the track, the implementation of the present invention will not be affected. Besides, suppose in the present embodiment that the black mark is taken as spacing mark and that the position of the spacing mark is just the demarcating position between adjacent tickets. In practice, the spacing mark can be blank interval and there may be a distance from the position where the spacing mark is located to the demarcating position between the adjacent tickets. In these situations, some simple changes should be made to the solution of the invention. Since this embodiment is obtained by making improvement on the basis of the paper cutting control device for ticket paper of the traditional ticket dispensing machine shown in FIG. 2, the same part in FIG. 3 as in FIG. 2 uses the same reference number.

As shown in FIG. 3, the paper inlet 100, the paper delivering roller 1, the first sensor 2, the cutter 3 and the second sensor 4 are provided in turn on the conveying track of the ticket paper along the moving direction of the ticket paper. Besides, the device further comprises a driving motor M and a controller (not shown in the figure). The controller, as core control part of the device, receives various detection signals, makes determination, and controls the movements of the cutter 3 and the driving motor M according to the result of the determination.

The paper delivering roller 1 comprises two rotatable cylindrical rollers oppositely disposed, wherein at least one is driven by the driving motor M. The ticket paper output by the paper inlet 100 is held in-between by the oppositely disposed cylindrical rollers of the paper delivering roller 1, and moves forward under the action of the friction force of the delivering roller 1 when the paper delivering roller 1 is rotated.

The first sensor 2 is a photoelectric sensor, which includes a light emitting element 2-1 and a photoelectric induction head 2-2 both being disposed perpendicular to the moving direction of the ticket paper, wherein the light emitting element is disposed at one side of the operation path of the ticket paper, and the photoelectric induction head is disposed at the other opposite side. The light emitted by the light emitting element 2-1 can pass through the light-color part of the ticket paper to irradiate the photoelectric induction head 2-2 and to make it in an illuminating status, and output corresponding level (high level or low level) as detection signal. However, the light emitted by the light emitting element 2-1 cannot pass through the black spacing mark B on the ticket paper. The output level of the photoelectric induction head 2-2 will be changed when the transmission path of light is blocked by the black spacing mark B, i.e. it may be changed from a high level to a low level, or the other way round, according to different element characteristics and circuit arrangements. The position where the light emitting element 2-1 irradiates and passes through on the operation path of the ticket paper is called detection position of the first sensor 2. The output level of the first sensor 2 will be changed when the spacing mark B of the ticket paper arrives at the detection position of the first sensor 2. Such change is delivered to the controller as spacing mark B arrival signal.

The cutter 3 is arranged in a direction perpendicular to the conveying track of the ticket paper and is capable of cutting the ticket paper moving on the conveying track. The cutting position of the cutter 3 to the ticket paper is located at the downstream of the detection position of the first sensor on the conveying track of the ticket paper at a line distance d1 from the first sensor 2. The time required for the ticket paper to move such a distance on the conveying track thereof can be obtained through experimentation or calculation under the normal speed of the driving motor M according to the specific value of the distance, and this time is called first predetermined time T1.

The second sensor 4 is a photoelectric sensor, which includes a light emitting element 4-1 and a photoelectric induction head 4-2 both being disposed perpendicular to the moving direction of the ticket paper, wherein the light emitting element is disposed at one side of the operation path of the ticket paper, and the photoelectric induction head is disposed at the other opposite side. The light emitted by the light emitting element 4-1 can irradiate the photoelectric induction head 4-2 to make it in an illuminating status, and output corresponding level (high level or low level). However, the output level of the photoelectric induction head 4-2 will be changed when the light emitted by the light emitting element 4-1 is blocked by the ticket paper, i.e. it may be changed from a high level to a low level, or the other way round, according to different element characteristics and circuit arrangements. The position where the light emitting element 4-1 irradiates and passes through on the operation path of the ticket paper is called detection position of the second sensor 4, and this position is at a distance d2 from the paper cutting position of the cutter 3, and before occurrence of the paper cutting action to the current ticket, the front end thereof can arrive at this position. When the current ticket has not yet arrived at this position, as there is no block at the detection position of the second sensor 4, the path of the light emitted by the light emitting element 4-1 to the photoelectric induction head 4-2 is clear, the output level of the photoelectric induction head 4-2 is changed into the level in the illuminating status. After the front end of the current ticket arrives at this position, the path of the light emitted by the light emitting element 4-1 of the second sensor 4 to the photoelectric induction head 4-2 is blocked by the front end of the current ticket, the output level of the photoelectric induction head 4-2 is changed. The level change will be delivered to the controller as detection signal of the front end of the current ticket arrival, and the controller judges accordingly that the front end of the current ticket has arrived at the detection position of the second sensor 4. In order to assure that the front end of the ticket paper can be detected by the second sensor 4 when it arrives at the paper cutting position, the locations of the first sensor 2 and second sensor 4 should satisfy the formula max(d1, d2)<H<(d1+d2), wherein H is the length of the ticket. The formula means that the length of the ticket should be greater than d1 and d2 and smaller than a summary of d1 and d2. The d2 can be set to be slightly smaller than H in order to obtain a better detection effect. With the above arrangement, the front end of the ticket is still not detected by the second sensor 4 when the spacing mark B of the current ticket is detected; and when the current ticket arrives at the paper cutting position, the front end of the current ticket has already been detected, and at this moment, the next spacing mark has not yet been detected by the first sensor 2. The detection result of the second sensor 4 thereby can function to judge whether the paper feeding mechanism works normally or not; moreover, the confusion that the first sensor 2 detects the spacing mark of the next ticket when the current ticket has not yet been cut can be avoided.

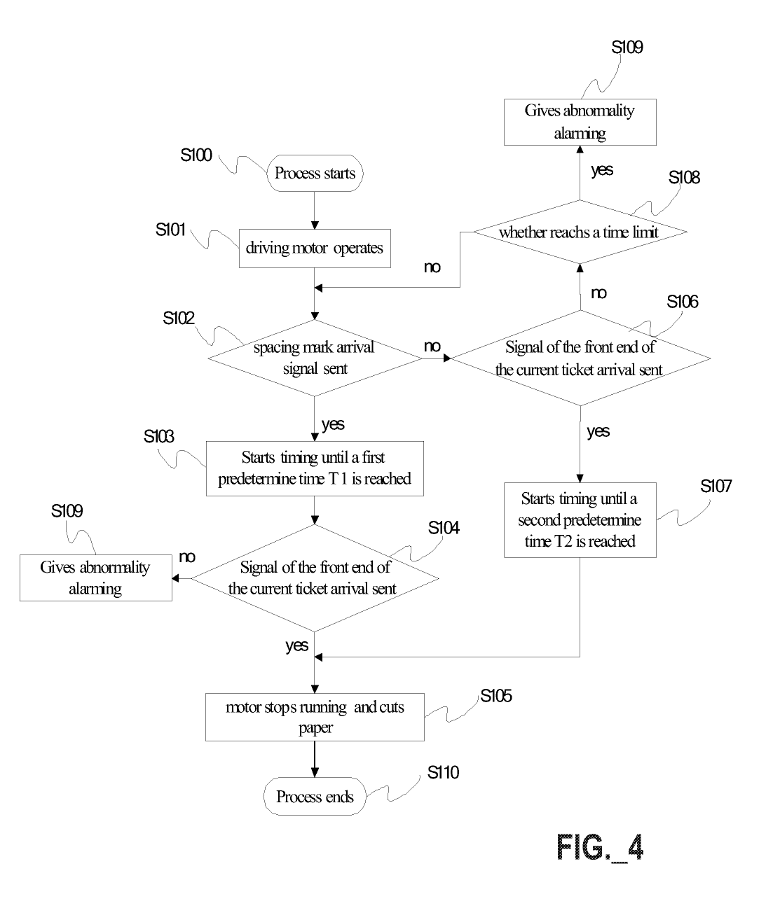

The basic structure of the paper cutting control device for ticket paper is described above. Corresponding controlling program still needs to be executed by the controller during the normal running thereof. FIG. 4 shows a control flow chart of the control device. The controlling process of the controller will be illustrated in conjunction with this flow chart.

Step S100, the process starts.

At this moment, the last ticket has been cut, the current ticket waiting to be printed and cut is located in a ready position and a new ticket dispensing instruction is received. In addition, at this moment, timing of the ticket dispensing this time is started so as to be compared with a predetermined time limit T3. This timing is called time limit timing.

Step S101, the driving motor M operates.

The rotation of the driving motor M can drive the paper delivering roller 1 to rotate, and the friction force of the paper delivering roller 1 can drive the ticket paper to move forward along the conveying track.

Step S102, judges whether the spacing mark arrival signal sent from the first sensor 2 is received; if so, goes to the step S103; if not, goes to the step S106.

Step S103: the controller starts timing until the first predetermined time T1 set in advance is reached.

As aforementioned, the first predetermined time T1 is set on the basis that the ticket paper moves a distance of d1 during the normal paper feeding. Therefore, after the driving motor M runs for the first predetermined time T1 taking the first sensor 2 detecting the spacing mark arrival signal as starting point, the spacing mark B just moves the distance d1, i.e. the spacing mark B arrives at the cutting position of the cutter 3.

Step S104, judges whether the signal of the front end of the current ticket arrival sent by the second sensor 4 is received; if so, goes to the step S105; if not, goes to the step S109.

Although during the normal paper feeding, the ticket paper moves a distance of d1 when running for the first predetermined time T1 starting from the first sensor 2 detecting the spacing mark B, in practice, the distance the ticket moves is caused unable to reach d1 since problems such as paper jamming or slipping between the paper delivering roller 1 and the ticket paper sometimes will occur on the conveying track. As the detection position of the second sensor 4 is located at the position where the front end of the current ticket necessarily will arrive when the current ticket arrives at the normal paper cutting position, it therefore can be judged whether the ticket paper feeding is normal according to whether the second sensor 4 sends the signal of the front end of the current ticket arrival. If the paper feeding is normal, the paper will be cut normally; and if the paper feeding is abnormal, an alarming process will be implemented.

A fault-tolerance counter can be provided considering the situation that the second sensor 4 may be insensitive to make judgment in a case of dust or paper scrap interference. Within the scope of the fault-tolerance times set by the counter, the step S105 will still be implemented to cut the ticket even if the second sensor 4 does not send the signal of the front end of the current ticket arrival when the first predetermined time T1 is reached, and meanwhile, the value of the counter is reduced by 1. After the value of the fault-tolerance counter is reduced to be 0, the process goes to the step S109 if the situation that the second sensor 4 does not send the signal of the front end of the current ticket arrival re-occurs when the first predetermined time T1 is reached. After the abnormal situation is eliminated, the fault-tolerance counter is reset to the initial value. The typical set value of the fault-tolerance times of the fault-tolerance counter is 1.

Step S105, the driving motor M stops running, and performs the paper cutting operation, and then, the process goes to the step S110.

It is the controller that controls the cutter 3 to perform the paper cutting action in this step. After the action is completed, the current ticket is separated from the ticket paper, and the next current ticket also arrives at the ready position to wait for next ticket dispensing cycle.

Step S106, judges whether the second sensor 4 sends the signal of the front end of the current ticket arrival; if so, goes to the step S107; and if not, goes to the step S108.

In the case where the spacing mark B is missed in printing, the first sensor 2 cannot detect the spacing mark B, and at this moment, the current ticket continues to move forward and the front end of which will arrive at the detection position of the second sensor 4. At this moment, the ticket has not yet arrived at the paper cutting position, and this time point can be taken as a timing start point.

Step S107, goes to the step S105 when the timing reaches the second predetermined time T2.

The second predetermined time T2 is the time span during which the ticket paper moves to the paper cutting position when the conveying track of which is normal after the second sensor 4 sends the signal of the current ticket of the front end arrival. This time span is obtained through experimentation or through calculation based on the paper feeding speed and the above mentioned values H, d1, d2, etc. Another opportunity of paper cutting timing can be provided with this step in the situation when the spacing mark B is absent, which is equivalent to insuring against the abnormal condition that the spacing mark B is absent. Due to this step, the paper cutting control device is enabled to have higher reliability.

Step S108, judges whether the paper feeding time is beyond the set time limit T3; if so, going to the step S109; if not, returns to the step S102 to continue paper feeding and obtains related detection signal.

The time limit T3 is the limit value of each ticket dispensing time. As aforementioned, the dispensing time is started to be timed when the ticket dispensing is started. It should be judged that the paper feeding is abnormal if neither the spacing mark arrival signal nor the signal of the front end of the current ticket arrival is received when the timed time goes beyond the predetermined time limit T3, and an abnormality alarm should be given.

Step S109, gives the abnormality alarm.

The paper feeding is meant abnormal when a negative judgment occurs in the step S104 and step S108, then the abnormality alarm should be given to remind the operator to deal with the abnormality. The abnormality alarm can be given in the mode such as light and alarm sound.

Step S110, the process ends.

One dispensing process is finished at this time, and the next ticket dispensing should be prepared. Each counter should be reset in this step.

In the above embodiment, the paper cutting control to the ticket paper is enabled to be more precise; and the occurring abnormality can be dealt with timely.

Some conditions in this embodiment can be changed. For example, the spacing mark B can be in the form of blank interval, and in this way, it is necessary for a sensor that can detect the blank interval be chosen.

Furthermore, the conveying track of the ticket paper is most likely to be a circular track, then the above sensors and the position of the cutter should be located surrounding the circular track, and the positional relation in which they are provided can be calculated in a circular line length. The line length refers to a cumulative length moving along the track that can be both straight-line track and circular-arc track.

Besides, the current ticket can be just at the paper cutting position when the second sensor 4 sends the signal of the front end of the ticket arrival. This situation can be considered as the limit case that the second predetermined time t2 is equal to 0.

A ticket dispensing machine having the above mentioned function of controlling paper cutting for ticket paper can be obtained just by applying the paper cutting control device for ticket paper provided in the embodiments above to the ticket dispensing machine.

Above descriptions are the preferred embodiments of the present invention. It should be indicated that the person skilled in the art also could make various improvements and modifications, without departing from the principle of the present invention. The improvements and modifications should be included in the protection scope of the present invention.

1. A paper cutting control device for ticket paper, comprising a driving motor, a first sensor, a cutter and a controller, the driving motor supplying power to a paper discharging movement to make the ticket paper move on a conveying track thereof, the first sensor being used for detecting a spacing mark between adjacent tickets of the ticket paper and sending a spacing mark arrival signal when the spacing mark is detected, the cutter being used for cutting the ticket paper, and a cutting position thereof being located on a downstream of a detection position of the first sensor on the conveying track of the ticket paper, the controller being used for receiving a detection result of each sensor and controlling actions of the driving motor and the cutter accordingly, wherein the paper cutting control device for ticket paper further comprises a second sensor on the conveying track of the ticket, which is used for detecting a front end of the ticket paper and sending a ticket arrival signal when the front end of the ticket paper is detected, and a detection position of the second sensor is located on a downstream of the cutter.

2. The paper cutting control device for ticket paper according to claim 1, wherein the second sensor has already detected or just detects that the front end of the ticket paper arrives at the detection position thereof when the ticket paper arrives at a correct cutting position.

3. The paper cutting control device for ticket paper according to claim 1, wherein the spacing mark between adjacent tickets is a black mark or a blank interval.

4. The paper cutting control device for ticket paper according to claim 1, wherein the first sensor and the second sensor are photoelectric sensors.

5. The paper cutting control device for ticket paper according to claim 1, wherein the controller controls in following way:
the controller starts timing if receiving the spacing mark arrival signal sent by the first sensor; and
if a signal of the front end of the ticket arrival sent by the second sensor has been received or is just received when the timing of the controller reaches a first predetermined time T1, the controller controls the driving motor to stop running at this moment and controls the cutter to cut the paper.

6. The paper cutting control device for ticket paper according to claim 5, wherein the first predetermined time allows an error range to be set.

7. The paper cutting control device for ticket paper according to claim 5, wherein an abnormality alarm indication is given if the signal of the front end of the ticket arrival sent by the second sensor has not yet been received when the timing of the controller reaches the first predetermined time T1.

8. The paper cutting control device for ticket paper according to claim 1, wherein the controller starts the timing when receiving the signal of the front end of the ticket arrival sent by the second sensor if the controller does not receive the spacing mark arrival signal sent by the first sensor but receives the signal of the front end of the ticket arrival sent by the second sensor, and the controller controls the driving motor to stop running and controls the cutter to cut the paper when the timing reaches a second predetermined time T2.

9. The paper cutting control device for ticket paper according to claim 1, wherein a time limit which is timed from starting delivering the paper is preset in the controller; and an abnormality alarm indication is given if the controller neither receives the spacing mark arrival signal sent by the first sensor nor receives the signal of the front end of the ticket arrival sent by the second sensor after the time limit is reached.

10. A ticket dispensing machine, having a paper cutting control device for ticket paper, the paper cutting control device for ticket paper comprising a driving motor, a first sensor, a cutter and a controller, the driving motor supplying power to a paper discharging movement to make the ticket paper move on a conveying track thereof, the first sensor being used for detecting a spacing mark between adjacent tickets of the ticket paper and sending a spacing mark arrival signal when the spacing mark is detected, the cutter being used for cutting the ticket paper, and a cutting position thereof being located on a downstream of a detection position of the first sensor on the conveying track of the ticket paper, the controller being used for receiving a detection result of each sensor and controlling actions of the driving motor and the cutter accordingly, wherein the paper cutting control device for ticket paper further comprises a second sensor on the conveying track of the ticket, which is used for detecting a front end of the ticket paper and sending a ticket arrival signal when the front end of the ticket paper is detected, and a detection position of the second sensor is located on a downstream of the cutter.

11. The ticket dispensing machine according to claim 10, wherein the second sensor has already detected or just detects that the front end of the ticket paper arrives at the detection position thereof when the ticket paper arrives at a correct cutting position.

12. The ticket dispensing machine according to claim 10, wherein the controller controls in following way:
the controller starts timing if receiving the spacing mark arrival signal sent by the first sensor; and
if a signal of the front end of the ticket arrival sent by the second sensor has been received or is just received when the timing of the controller reaches a first predetermined time T1, the controller controls the driving motor to stop running at this moment and controls the cutter to cut the paper

13. The paper cutting control device for ticket paper according to claim 2, wherein the controller controls in following way:
the controller starts timing if receiving the spacing mark arrival signal sent by the first sensor; and
if a signal of the front end of the ticket arrival sent by the second sensor has been received or is just received when the timing of the controller reaches a first predetermined time T1, the controller controls the driving motor to stop running at this moment and controls the cutter to cut the paper.

14. The paper cutting control device for ticket paper according to claim 13, wherein the first predetermined time allows an error range to be set.

15. The paper cutting control device for ticket paper according to claim 13, wherein an abnormality alarm indication is given if the signal of the front end of the ticket arrival sent by the second sensor has not yet been received when the timing of the controller reaches the first predetermined time T1.

16. The paper cutting control device for ticket paper according to claim 2, wherein the controller starts the timing when receiving the signal of the front end of the ticket arrival sent by the second sensor if the controller does not receive the spacing mark arrival signal sent by the first sensor but receives the signal of the front end of the ticket arrival sent by the second sensor, and the controller controls the driving motor to stop running and controls the cutter to cut the paper when the timing reaches a second predetermined time T2.

17. The paper cutting control device for ticket paper according to claim 2, wherein a time limit which is timed from starting delivering the paper is preset in the controller; and an abnormality alarm indication is given if the controller neither receives the spacing mark arrival signal sent by the first sensor nor receives the signal of the front end of the ticket arrival sent by the second sensor after the time limit is reached.
